(19) United States
(12) Patent Application Publication
(10) Pub. No.: US 2025/0135416 A1
(43) Pub. Date: May 1, 2025

(54) Nanobubble formation by flow regime switching using a Tesla Valve

(71) Applicant: Board of Trustees of Western Michigan University, Kalamazoo, MI (US)

(72) Inventors: Andre R. Venter, Kalamazoo, MI (US); George Joseph, Kalamazoo, MI (US); Bincy Binny, Kalamazoo, MI (US); James Arthur Thomas Richardson, Kalamazoo, MI (US)

(21) Appl. No.: 18/929,565

(22) Filed: Oct. 28, 2024

Related U.S. Application Data
(60) Provisional application No. 63/593,292, filed on Oct. 26, 2023.

(51) Int. Cl. B01F 31/65; B01F 23/23; B01F 23/232; B01F 23/237; B01F 23/2375; B01F 25/421; B01F 31/80

(52) U.S. Cl. CPC B01F 31/651; B01F 23/232; B01F 23/2375; B01F 23/23762; B01F 23/238; B01F 25/421; B01F 31/80

(57) ABSTRACT

Embodiments include a system for generating nanobubbles in a solvent, including a device for generating a reverse and forward flow in the solvent, wherein the solvent has one or more gases dissolved in it; and a Tesla valve fluidly coupled to the device, wherein the device pushes the solvent through the Tesla valve one or more times alternatingly in a forward and reverse direction to generate nanobubbles of a desired concentration and size. Aspects include a method for generating nanobubbles in a solvent, including filling a device with a desired solvent containing one or more gases dissolved in it; wherein the device is capable of generating a reverse and forward flow in the solvent, and wherein a Tesla valve is fluidly coupled to the device; and using the device to push the solvent through the Tesla valve one or more times alternatingly in forward and reverse directions to generate nanobubbles.

### CROSS-REFERENCE TO RELATED APPLICATIONS

This application claims the benefit of U.S. Provisional Application No. 63/593,292, filed Oct. 26, 2023. The entire contents of the prior application are incorporated by reference herein.

### STATEMENT REGARDING FEDERALLY SPONSORED RESEARCH OR DEVELOPMENT

This invention was made with government support under 2003379 awarded by the National Science Foundation. The government has certain rights in the invention.

### TECHNICAL FIELD

The present disclosure relates to systems and methods for producing nanobubbles, i.e., gas bubbles in solvents with improved and unique properties, around 200 nm in diameter using a novel and cost-effective, low-energy method using Tesla valve flow cycling.

### BACKGROUND OF THE INVENTION

Nanobubbles (NBs) are very small gas concavities in solution, and when their sizes reach diameters around 200 nm they exhibit special qualities with widespread application. We introduce a novel, cost-effective method for the generation of nanobubbles by flow cycling through a Tesla valve, a valvular conduit without moving parts. We compare the performance of Tesla valve flow cycling with other previously reported methods for laboratory scale nanobubble generation such as ultrasonication and pressure cycling methods. The comparison includes bubble diameter, bubble concentration and zeta potential under individually optimized conditions. The average bubble diameter generated by the Tesla valve was measured at 110 nm by NTA, which is similar to sonication but small compared to the bubbles produced by the pressure cycling method (140 nm). Additionally, the average concentration of bubbles created by the Tesla valve was 3.8E8 particles/mL, more than sonication at 3.0E8 particles/mL, but fewer than pressure cycling at 2.6E9 particles/mL. The surface charge was recorded at −33 mV, just below sonication at −36 mV but larger than pressure cycling at −21.3 mV.

The results indicate that flow cycling through a Tesla valve generates NBs in the 100-200 nm range, which compares favourably to the alternative laboratory scale methods while promising lower energy consumption and easy scalability for future industrial applications.

### SUMMARY OF THE INVENTION

Embodiments of the present disclosure may include a system for generating nanobubbles in a solvent, the system comprising: a device for generating a reverse and forward flow in the solvent, wherein the solvent has one or more gases dissolved in it; and a Tesla valve fluidly coupled to the device, wherein the device pushes the solvent through the Tesla valve one or more times alternatingly in a forward and reverse direction to generate nanobubbles of a desired concentration and size.

Aspects of the present invention may include a method for generating nanobubbles in a solvent, including filling a device with a desired solvent containing one or more gases dissolved in it; wherein the device is capable of generating a reverse and forward flow in the solvent, and wherein a Tesla valve is fluidly coupled to the device; and using the device to push the solvent through the Tesla valve one or more times alternatingly in a forward and reverse direction to generate nanobubbles of a desired concentration and size.

### BRIEF DESCRIPTION OF THE DRAWINGS

FIG. 1 depicts an example Tesla valve from the original 1920s Tesla patent

FIG. 2 (a) depicts a 3-D printed Tesla valve connected to two 10 mL Luerlock syringes; (b) depicts an example embodiment schematic of an automated system;

FIG. 3 depicts optimization of flow cycles of the Tesla Valve for the creation of nanobubbles;

FIG. 4 depicts optimization of cycles of the pressure cycling method for the creation of nanobubbles;

FIG. 5 shows time optimization of ultrasonication method;

FIG. 6 shows the radius of bubbles formed in 3% ethanol from CO₂ by (a) Tesla Valve, (b) Pressure cycling, (c) Sonication, and from air by (d) Tesla Valve, (e) Pressure cycling (f) Sonication at optimized conditions;

FIG. 7 depicts size distribution of CO2 bubbles under optimized conditions by (a) Tesla valve, (b) Pressure cycling, (c) Sonication methods using NTA.

### DETAILED DESCRIPTION

Bubbles below 1 μm exhibit special properties when their diameters approach 200 nm and are referred to as nanobubbles in the literature. Unlike microbubbles, frequently characterized as bubbles with a diameter between 10 and 50 μm, nanobubbles do not coalesce to burst at liquid surfaces but can remain stable in solution for extended periods of time.[1] These concavities share certain characteristics such as low buoyancy, negative surface charges, the formation of free radicals, enhanced water mobility, high internal pressure, enormous surface to volume ratio, and a high gas dissolution rate. Thermodynamic study at room temperature and pressure indicates that aqueous bulk bubbles with diameters smaller than 180 nm do not begin to dissolve spontaneously. [2] Even so, NBs hold the promise of overcoming gas-in-liquid solubility barriers by providing a significant source of dissolved gases, for example CO₂ or air in solution.

In general, the zeta potential measurement of micro- and nanobubbles are negative, but the values change with different types of gases [3,4] and solvent. [5] The zeta potential value for carbon dioxide nanobubbles in water ranges between −21 to −36−mV. Other gases such as air (−17 to −20 mV), nitrogen (−29 to −35 mV), oxygen (34 to −45 mV) and xenon (−11 to −22 mV) also have negative zeta potentials. [3] It has been suggested that the negative zeta potential of nanobubbles leads to the formation of an electrical double layer and that this provides the long life times of the nanobubbles (NBs). [6]

These characteristics make NBs very promising for use in a wide range of cutting-edge scientific domains.[7-9] Nanobubbles are most frequently used in environmental science and industry for wastewater treatment, pesticide removal, field irrigation, solid surface cleaning, and many other applications.[10-12] NBs are employed as the contrast for ultrasound sonography imaging (USG), [13] and future medical applications may include drug administration and tumor killing. [14] Plants and aquatic life also thrive miraculously when irrigated with NB containing air and oxygen. [15] In addition, nanobubbles offer intriguing opportunities to learn more about gas-liquid interfaces and develop novel transformative applications. [16]

There are numerous methods reported for producing nanobubbles. A few notable examples include the spiral-liquid-flow generator, [17] ejector-type generator, [18] depressurising methods, [19] a Venturi-tubelnozzle-based generator, [20] periodic pressure change [21] and ultrasonication. [4] These methods have various disadvantage, depending on their process parameters or other characteristics, such as flow regime, heat generation during process, phase pressures, or the high cost of instrumentation. [23]

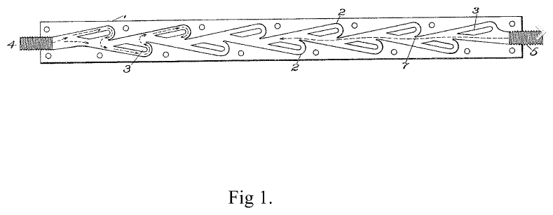

Here we are introducing a novel, cost-effective, sustainable, and durable method for easy generation of nanobubbles using a Tesla valve. The Tesla valve is a valve without moving parts and also known as a valvular conduit. [24] Nikola Tesla invented this technology and received a US patent for it in 1920. Promising applications have been demonstrated in microfluids and pulse jet engines. [25-27] Since it has no moving parts, it provides durability, scalability and ease of fabrication. [28,29] An example of Tesla's Tesla valve design is shown in FIG. 1.

Using the Tesla valve, it is possible to induce turbulent flow of fluids at lower Reynolds numbers. [30] The Reynolds number (Re), a dimensionless quantity that gauges the relationship between inertial and viscous forces, aids in the prediction of fluid flow patterns under various conditions. Laminar flow (Re<4000) predominates in flows at low Reynolds numbers, whereas turbulent flow (Re>4000) occurs at high Reynolds numbers. In a Tesla valve, the flow differs in the forward and reverse direction. The Tesla valve can produce early turbulence at lower Reynolds number in the reverse flow because of its complex geometry. While flow is laminar in the forward direction, reversing the flow results in a significant flow barrier due to the induced turbulence. Studies shows that when the length to depth ratio (LD) of the valve is less than 40, early turbulence can be achieved in the reverse direction at low Re. [30]

### Example 1. Nanobubble Generation Comparisons

We compare the generation of NBs using flow regime switching in the Tesla valve with two other laboratory-scale NB generation methodologies, ultrasonication [22] and pressure cycling. [31] Our comparison includes bubble size distributions, concentration and zeta potential. Size distributions were determined by dynamic light scattering and nanoparticle tracking analysis, which also provided bubble concentrations.

Carbonation of a 3% ethanol solution was obtained using a SodaStream soda water maker (Mount Laurel, New Jersey, USA). Aerated water was produced by bubbling pure air (Airgas, Gwinnett, Georgia) into MilliQ water (18.5 MΩ·cm) (Thermo Scientific, Langenselbold, Germany), 99.5% pure ethyl alcohol was obtained from Sigma Aldrich (St. Louis, Missouri). Siraya Tech Blu resin from Siraya Tech (San Gabriel, California) was used for 3D printing. For pressure cycling, a 10 ml polypropylene syringe was used (Norm-Ject Luer lock sterile syringes, Germany).

Carbonated and aerated 3% ethanol solution was used as samples. All samples were prepared at room temperature. The same aerated or carbonated sample was split between the three compared methods for subsequent NB generation.

### Example 2. Tesla Valve (Flow Regime Cycling)

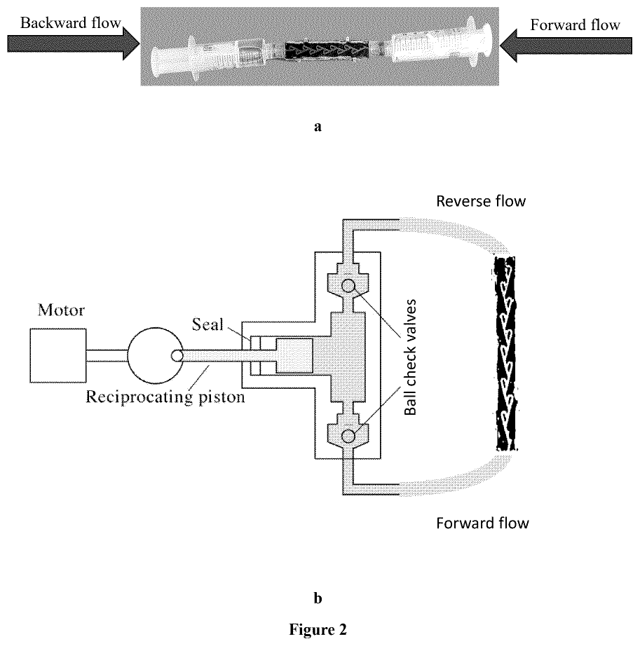

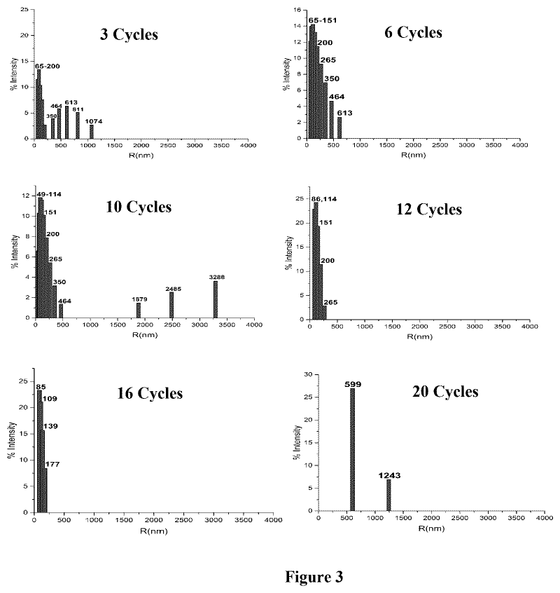

A Tesla valve was 3D-printed with a length of 84 mm and a depth of 4 mm to give an ID ratio=21. When the length to depth ratio (L/D) of the valve is less than 40, early turbulence can be achieved in the reverse direction at low Re. [30] The Tesla valve was printed using a Phrozen Sonic Mini 8K LCD Resin 3D printer using Siraya Tech Blu 3D printer resin. The print file was based on a plan published by Yunhao Bao et al., [32] Nanobubble generation was optimized to 12 cycles as shown in FIG. 3. One cycle comprises of a forward and backward directional flow as shown in FIG. 2a, which depicts a 3-D printed Tesla valve connected to two 10 mL Luerlock syringes. Laminar flow is obtained by depressing the plunger on the right, while turbulent flow is created by depressing the plunger on the left.

Similarly, in some embodiments, the Tesla valve may be automated, using a motor coupled to a reciprocating piston and seal, which seals a chamber containing the solvent(s) and gas(es) of interest. An example system is shown in FIG. 2b. The action of the piston moves two ball check valves back and forth to alternate reverse and forward flow through the Tesla value which is in communication with the liquid in the ball check valve, generating the required concentration and size of nanobubbles.

### Example 3. The Pressure Cycling Method

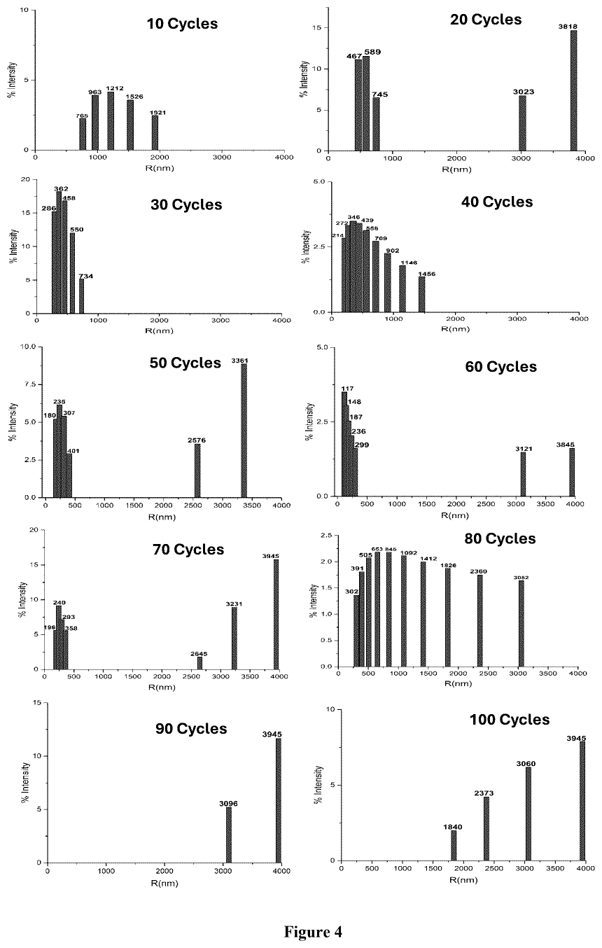

A 10 mL polypropylene syringe was filled with the carbonated solvent sample and the syringe tip was sealed with a Luer lock cap after any trapped air was released. Once the syringe plunger is quickly pulled, the water is depressurized. This is followed by an instantaneous release of the plunger, which travels at a relatively high speed due to the pressure differential. These two actions constitute a single cycle of the nanobubble creation process. [31] This method requires many consecutive cycles to generate an adequate amount of nanobubbles. The cycle number was optimised to 60 as shown in FIG. 4.

### Example 4. The Sonication Method

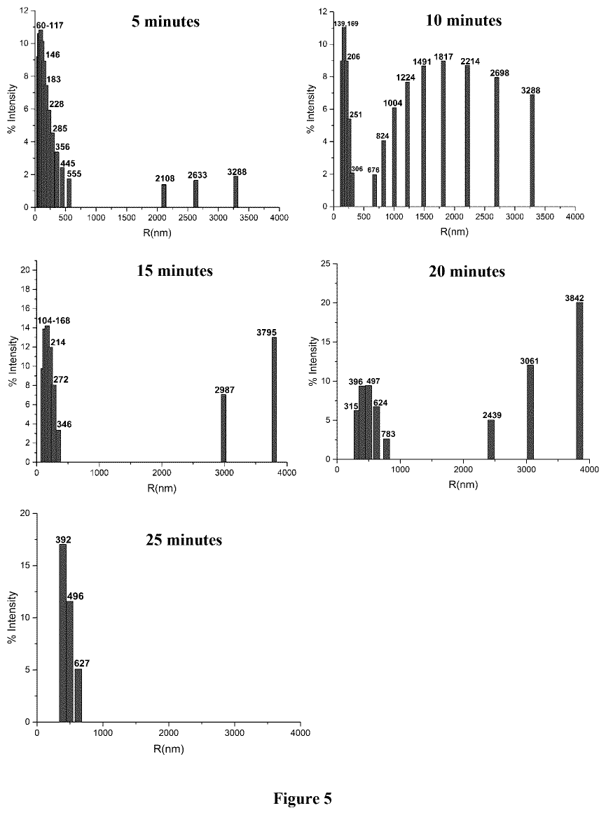

A 15 ml aliquot of carbonated or aerated solvent was sonicated using a Misonix Ultrasonic Liquid Processor XL-2020 probe (Misonix Farmingdale, NY) for 5 min at 10 kHz. Optimization data is shown in FIG. 5. [4,33]

### Example 5. Characterization

Bubble Size Distribution. The size distribution of nanoscale bubbles after the treatment with each method using CO₂ dissolved 3% ethanol:water was measured using dynamic light scattering (DLS) (Dynapro Titan, Wyatt Technology Corporation, Santa Barbara, CA). The DLS instrument was operated at 20% power of a 220W laser beam at 589 nm using a cuvette with a one centimeter light transmission channel. [34]

Determination of concentration of bubbles formed. The number of bubbles formed after the treatment with each optimized method using CO₂ dissolved 3% ethanol:water were determined by PMX-230-Z-TWIN-488/640 Laser Zeta View Nanoparticle Tracking Analysis system (NTA) (Particle Metrix, Ammersse, Germany). For each measurement, we used the following settings: Camera sensitivity for all samples: 82; Shutter: 110; Cell temperature: 24.09° C. For the analysis parameters were, Maximum area: 1000, Minimum area 10, Minimum brightness: 18.

### Example 6. Optimization of Tesla Valve Cycle Number

The repeated cycling of the flow direction in the Tesla valve with the subsequent cycling of flow regimes between laminar and turbulent flows leads to the efficient formation of nanobubbles as shown in FIG. 3.

The cycle number was optimised using cycle numbers of 3, 6, 10, 12, 16, and 20 of a 5 ml carbonated solution containing 3% ethanol in water. After the solution is repeatedly passed through the Tesla valve, we determined the radius of bubbles formed using DLS. An optimum appears to be 12 cycles, where almost 50% of the generated bubbles have radii in the 86 and 114 nm distribution classes. Cycle numbers up to 10 also generate nanobubbles but with a wider distribution that includes microbubbles.

### Example 7. Optimization of Cycle Number for the Pressure Cycling Method

The repeated cycling of pulling and release of syringe plunger leads to the efficient formation of nanobubbles as shown in FIG. 4.

The cycle number was optimised using cycle numbers of 10, 20, 30, 40, 50, 60, 70, 80, 90 and 100 of a 5 ml carbonated solution containing 3% ethanol in water. The solution is repeatedly depressurized by pulling the plunger and determined the radius of bubbles formed using DLS. An optimum appears to be 60 cycles, where the generated bubbles have radii between 117 and 300 nm.

### Example 8. Optimization of Sonication Time for the Ultra Sonication Method

The sample is subjected to different sonication times of 5, 10, 15, 20, 25 minutes using an ultra sonicator, which forms effective formation of nanobubbles, as depicted in FIG. 5. From our results, we confirmed that 5 minutes of sonication of the sample forms bubbles with radii ranging between 60-555 nm.

### Example 9. Size Comparison Between Nanobubbles Formed by Tesla Valve, Pressure Cycling, and Sonication

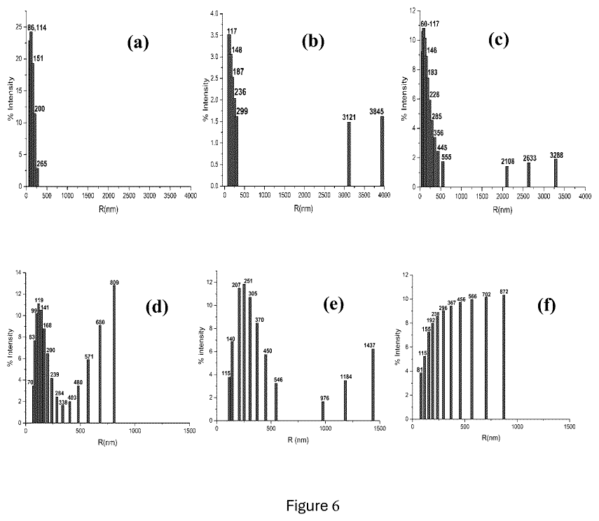

The results obtained were compared with two other previously reported methods for nanobubble production, pressure cycling and sonication. The radius of bubbles formed at optimized conditions for each method were measured by DLS and compared in FIG. 6 which shows the radius distributions of bubbles formed in 3% ethanol from CO₂ by (a) Tesla Valve, (b) Pressure cycling, (c) Sonication, and from air by (d) Tesla Valve, (e) Pressure cycling (f) Sonication.

The radius of CO₂ bubbles measured from the three different methods show the Tesla valve's ability to produce small nanobubbles with a tighter radii distribution and higher percentage formation ranging from 86 to 265 nm as compared to those created by the pressure cycling (117-299 nm) and sonication methods (60-555 nm). In addition, under these conditions no microbubbles were created by the Tesla Valve.

The Tesla valve produced air bubbles with radii 70 to 571 nm as compared to those created by pressure cycling (115 to 546 nm) and sonication methods (81 to 566 nm). While the spread in bubble sizes are similar, the Tesla Valve produced bubbles with a higher bubble fractions in the smaller bubble region. As previously noted smaller bubbles are obtained from CO₂ than with air. [35]

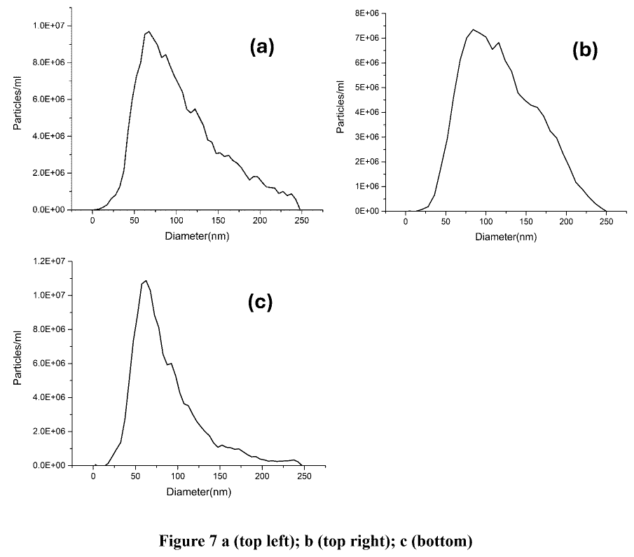

Bubble sizes were also determined by NTA, as shown in FIG. 7. When measuring nanobubble sizes, NTA typically shows smaller sizes compared to DLS because NTA analyzes individual particles, meaning it is not biased towards larger particles, while DLS measures the bulk scattering intensity, which is heavily influenced by larger particles in the sample, leading to an apparent larger average size; essentially, DLS is more sensitive to larger bubbles, causing the measured size to appear larger than what NTA detects. [36-39]

### Example 10. Number of Bubbles and Zeta Potential Comparison Between Tesla Valve, Pressure Cycling and Sonication

According to an earlier thermodynamic study at room temperature and pressure, an aqueous bulk bubble having a diameter below 200 nm does not dissolve spontaneously. [2] The average size of bubbles, concentrations and zetapotential is shown in Table 1. Pressure cycling method produces a greater number of bubbles which is followed by Tesla valve and Sonication method. Zeta potential results indicates that the generation method also influences the surface charge of the bubbles.

TABLE 1
Diameter, concentration and zeta potential of CO₂ nanobubbles
under optimised condition of each method measured by NTA.

| | Weighted Average | | Concentration | | |
|---|---|---|---|---|---|
| | Size | | (particles/ml) | | Zeta |
| | | Relative | | Relative | Poten- |
| | Diameter | Std. | | Std. | tial |
| Method | (nm) | Dev % | | Dev % | (mV) |
| Pressure | 143 | 3.58 | 2.61E9 | 19.19 | −21.27 |
| Cycling | | | | | |
| Sonication | 99 | 11.00 | 2.99E8 | 14.04 | −36.17 |
| Tesla Valve | 110 | 8.27 | 3.79E8 | 7.43 | −33.30 |

The generation of nanobubbles by flow regime switching using a Tesla valve appears to be equivalent or better than comparative standard laboratory scale batch methods of nanobubble preparation. Under optimized conditions for each method, the Tesla valve produced smaller bubbles over a narrower distribution of sizes. In addition, this technique has the advantage of requiring fewer cycles compared to the syringe method, not requiring a high wattage, high frequency alternating current power supply as for sonication, and is thus cost effective compared to other methods, promising the ability for low energy usage during large scale implementation.

### REFERENCES

(1) Agarwal, A.; Ng, W. J.; Liu, Y. Principle and Applications of Microbubble and Nanobubble Technology for Water Treatment. Chemosphere 2011, 84 (9), 1175-1180. https://doi.org/10.1016/j.chemosphere.2011.05.054.
(2) Vehmas, T.; Makkonen, L. Metastable Nanobubbles. ACS Omega 2021, 6 (12), 8021-8027. https://doi.org/10.1021/acsomega.0c05384.
(3) Ushikubo, F. Y.; Enari, M.; Furukawa, T.; Nakagawa, R.; Makino, Y.; Kawagoe, Y.; Oshita, S. Zeta-Potential of Micro- and/or Nano-Bubbles in Water Produced by Some Kinds of Gases. IFAC Proc. Vol. 2010, 3 (PART 1). https://doi.org/10.3182/20101206-3-jp-3009.00050.
(4) Kim, J. Y.; Song, M. G.; Kim, J. D. Zeta Potential of Nanobubbles Generated by Ultrasonication in Aqueous Alkyl Polyglycoside Solutions. J. Colloid Interface Sci. 2000, 223 (2), 285-291. https://doi.org/10.1006/jcis.1999.6663.
(5) Yang, Y.; Boysen, R. I.; Kulsing, C.; Matyska, M. T.; Pesek, J. J.; Hearn, M. T. W. Analysis of Polar Peptides Using a Silica Hydride Column and High Aqueous Content Mobile Phases. J. Sep. Sci. 2013, 36 (18), 3019-3025. https://doi.org/10.1002/jssc.201300376.
(6) Nirmalkar, N.; Pacek, A. W.; Barigou, M. Interpreting the Interfacial and Colloidal Stability of Bulk Nanobubbles. Soft Matter 2018, 14 (47), 9643-9656. https://doi.org/10.1039/c8sm01949e.
(7) Ahmed, A. K. A.; Sun, C.; Hua, L.; Zhang, Z.; Zhang, Y.; Zhang, W.; Marhaba, T. Generation of Nanobubbles by Ceramic Membrane Filters: The Dependence of Bubble Size and Zeta Potential on Surface Coating, Pore Size and Injected Gas Pressure. Chemosphere 2018, 203, 327-335. https://doi.org/10.1016/j.chemosphere.2018.03.157.
(8) Thi Phan, K. K.; Truong, T.; Wang, Y.; Bhandari, B. Nanobubbles: Fundamental Characteristics and Applications in Food Processing. Trends Food Sci. Technol. 2020, 95, 118-130. https://doi.org/10.1016/j.tifs.2019.11.019.
(9) Gurung, A.; Dahl, O.; Jansson, K. The Fundamental Phenomena of Nanobubbles and Their Behavior in Wastewater Treatment Technologies. Geosystem Eng. 2016, 19 (3), 133-142. https://doi.org/10.1080/12269328.2016.1153987.
(10) Chu, L. B.; Xing, X. H.; Yu, A. F.; Zhou, Y. N.; Sun, X. L.; Jurcik, B. Enhanced Ozonation of Simulated Dyestuff Wastewater by Microbubbles. Chemosphere 2007, 68 (10), 1854-1860. https://doi.org/10.1016/j.chemosphere.2007.03.014.
(11) Ikeura, H.; Kobayashi, F.; Tamaki, M. Removal of Residual Pesticide, Fenitrothion, in Vegetables by Using Ozone Microbubbles Generated by Different Methods. J. Food Eng. 2011, 103 (3), 345-349. https://doi.org/10.1016/j.jfoodeng.2010.11.002.
(12) Minamikawa, K.; Takahashi, M.; Makino, T.; Tago, K.; Hayatsu, M. Irrigation with Oxygen-Nanobubble Water Can Reduce Methane Emission and Arsenic Dissolution in a Flooded Rice Paddy. Environ. Res. Lett. 2015, 10 (8), 84012. https://doi.org/10.1088/1748-9326/10/8/084012.
(13) Krupka, T. M.; Solorio, L.; Wilson, R. E.; Wu, H.; Azar, N.; Exner, A. A. Formulation and Characterization of Echogenic Lipid-Pluronic Nanobubbles. Mol. Pharm. 2010, 7 (1), 49-59. https://doi.org/10.1021/mp9001816.
(14) Ohmori, M.; Haruta, K.; Kamimura, S.; Koike, H.; Uchida, T.; Takeyama, H. A Simple Method for Nanobubble Generation and Stability of the Bubbles. J. Environ. Biotechnol. 2015, 15 (1), 41-44.
(15) Ebina, K.; Shi, K.; Hirao, M.; Hashimoto, J.; Kawato, Y.; Kaneshiro, S.; Morimoto, T.; Koizumi, K.; Yoshikawa, H. Oxygen and Air Nanobubble Water Solution Promote the Growth of Plants, Fishes, and Mice. PLoS One 2013, 8 (6), 2-8. https://doi.org/10.1371/journal.pone.0065339.
(16) Antonio Cerron-Calle, G.; Luna Magdaleno, A.; Graf, J. C.; Apul, O. G.; Garcia-Segura, S. Elucidating CO2 Nanobubble Interfacial Reactivity and Impacts on Water Chemistry. J. Colloid Interface Sci. 2022, 607, 720-728. https://doi.org/10.1016/j.jcis.2021.09.033.
(17) Li, H.; Hu, L.; Xia, Z. Impact of Groundwater Salinity on Bioremediation Enhanced by Micro-Nano Bubbles. Materials (Basel). 2013, 6 (9), 3676-3687. https://doi.org/10.3390/ma6093676.
(18) Nakatake, Y.; Kisu, S.; Shigyo, K.; Eguchi, T.; Watanabe, T. Effect of Nano Air-Bubbles Mixed into Gas Oil on Common-Rail Diesel Engine. Energy 2013, 59, 233-239. https://doi.org/10.1016/j.energy.2013.06.065.
(19) Etchepare, R.; Azevedo, A.; Calgaroto, S.; Rubio, J. Removal of Ferric Hydroxide by Flotation with Micro and Nanobubbles. Sep. Purif. Technol. 2017, 184, 347-353. https://doi.org/10.1016fj.seppur.2017.05.014.
(20) Pourkarimi, Z.; Rezai, B.; Noaparast, M. Effective Parameters on Generation of Nanobubbles by Cavitation Method for Froth Flotation Applications. Physicochem. Probl. Miner. Process. 2017, 53 (2), 920-942. https://doi.org/10.5277/ppmp170220.
(21) Wang, Q.; Zhao, H.; Qi, N.; Qin, Y.; Zhang, X.; Li, Y. Generation and Stability of Size-Adjustable Bulk Nanobubbles Based on Periodic Pressure Change. Sci. Rep. 2019, 9 (1), 1-9. https://doi.org/10.1038/s41598-018-38066-5.
(22) Cho, S. H.; Kim, J. Y.; Chun, J. H.; Kim, J. D. Ultrasonic Formation of Nanobubbles and Their Zeta-Potentials in Aqueous Electrolyte and Surfactant Solutions. Colloids Surfaces A Physicochem. Eng. Asp. 2005, 269 (1-3), 28-34. https://doi.org/10.1016/j.colsurfa.2005.06.063.
(23) Ulatowski, K.; Sobieszuk, P. Gas Nanobubble Dispersions as the Important Agent in Environmental Processes—Generation Methods Review. Water Environ. J. 2020, 34 (S1), 772-790. https://doi.org/10.1111/wej.12577.
(24) Testla, N. U.S. Pat. No. 1,329,559. 1920.
(25) Ogorelec, B. Valveless Pulsejet Engines 1.5-a Historical Review of Valveless Pulsejet Designs. 2005, 1-35.
(26) Bardell, R. L.; Forster, F. K. Impedances for Design of Microfluidic Systems. Micro Total Anal. Syst. '98 1998, 299-302. https://doi.org/10.1007/978-94-011-5286-0_70.
(27) Deng, Y.; Liu, Z.; Zhang, P.; Wu, Y.; Korvink, J. G. Optimization of No-Moving Part Fluidic Resistance Microvalves with Low Reynolds Number. Proc. IEEE Int. Conf. Micro Electro Mech. Syst. 2010, No. February, 67-70. https://doi.org/10.1109/MEMSYS.2010.5442565.
(28) Gamboa, A. R.; Morris, C. J.; Forster, F. K. Improvements in Fixed-Valve Micropump Performance through Shape Optimization of Valves. J. Fluids Eng. Trans. ASME 2005, 127 (2), 339-346. https://doi.org/10.1115/1.1891151.
(29) Stith, D. The Tesla Valve—A Fluidic Diode. Phys. Teach. 2019, 57 (3), 201-201. https://doi.org/10.1119/1.5092491.
(30) Nguyen, Q. M.; Abouezzi, J.; Ristroph, L. Early Turbulence and Pulsatile Flows Enhance Diodicity of Tesla's Macrofluidic Valve. Nat. Commun. 2021, 12 (1). https://doi.org/10.1038/s41467-021-23009-y.
(31) Ferraro, G.; Jadhav, A. J.; Barigou, M. A Henry's Law Method for Generating Bulk Nanobubbles. Nanoscale 2020, 12 (29), 15869-15879. https://doi.org/10.1039/d0nr03332d.
(32) Bao, Y.; Wang, H. Numerical Study on Flow and Heat Transfer Characteristics of a Novel Tesla Valve with Improved Evaluation Method. Int. J. Heat Mass Transf. 2022, 187, 122540. https://doi.org/10.1016/j.ijheatmasstransfer.2022.122540.
(33) Yasuda, K.; Matsushima, H.; Asakura, Y. Generation and Reduction of Bulk Nanobubbles by Ultrasonic Irradiation. Chem. Eng. Sci. 2019, 195, 455-461. https://doi.org/10.1016/j.ces.2018.09.044.
(34) Xia, X. X.; Wang, M.; Lin, Y.; Xu, Q.; Kaplan, D. L. Hydrophobic Drug-Triggered Self-Assembly of Nanoparticles from Silk-Elastin-like Protein Polymers for Drug Delivery. Biomacromolecules 2014, 15 (3), 908-914. https://doi.org/10.1021/bm4017594.
(35) Onda, T. Bubbling in Carbon Dioxide Aqueous Solutions Containing Fine Air Bubbles. Colloids Surfaces A Physicochem. Eng. Asp. 2023, 667 (January), 131406. https://doi.org/10.1016/j.colsurfa.2023.131406.
(36) Han, Z.; Chen, H.; He, C.; Dodbiba, G.; Otsuki, A.; Wei, Y.; Fujita, T. Nanobubble Size Distribution Measurement by Interactive Force Apparatus under an Electric Field. Sci. Rep. 2023, 13 (1), 1-12. https://doi.org/10.1038/s41598-023-30811-9.
(37) Abenojar, E. C.; Bederman, I.; de Leon, A. C.; Zhu, J.; Hadley, J.; Kolios, M. C.; Exner, A. A. Theoretical and Experimental Gas Volume Quantification of Micro- and Nanobubble Ultrasound Contrast Agents. Pharmaceutics 2020, 12 (3). https://doi.org/10.3390/pharmaceutics12030208.
(38) Nirmalkar, N.; Pacek, A. W.; Barigou, M. On the Existence and Stability of Bulk Nanobubbles. Langmuir 2018, 34 (37), 10964-10973. https://doi.org/10.1021/acs.langmuir.8b01163.
(39) Li, M.; Ma, X.; Eisener, J.; Pfeiffer, P.; Ohl, C. D.; Sun, C. How Bulk Nanobubbles Are Stable over a Wide Range of Temperatures. J. Colloid Interface Sci. 2021, 596, 184-198. https://doi.org/10.1016/j.jcis.2021.03.064.

1. A system for generating nanobubbles in a solvent, the system comprising:
a device for generating a reverse and forward flow in the solvent, wherein the solvent has one or more gases dissolved in it; and
a Tesla valve fluidly coupled to the device, wherein the device pushes the solvent through the Tesla valve one or more times alternatingly in a forward and reverse direction to generate nanobubbles of a desired concentration and size.

2. A method for generating nanobubbles in a solvent, comprising:
filling a device with a desired solvent containing one or more gases dissolved in it;
wherein the device is capable of generating a reverse and forward flow in the solvent, and wherein
a Tesla valve is fluidly coupled to the device; and
using the device to push the solvent through the Tesla valve one or more times alternatingly in a forward and reverse direction to generate nanobubbles of a desired concentration and size.
